(19) United States
(12) Patent Application Publication
(10) Pub. No.: US 2013/0276531 A1
(43) Pub. Date: Oct. 24, 2013

(54) FUEL DELIVERY UNIT

(71) Applicants: Hans-Guenter Benner, Kriftel (DE); Bernd Pauer, Eppstein (DE)

(72) Inventors: Hans-Guenter Benner, Kriftel (DE); Bernd Pauer, Eppstein (DE)

(21) Appl. No.: 13/994,962

(22) PCT Filed: Dec. 13, 2011
(86) PCT No.: PCT/EP2011/072503

§ 371 Date: Jun. 17, 2013

(30) Foreign Application Priority Data
Dec. 17, 2010 (DE) 10 2010 054 883.9

(51) Int. Cl. G01F 23/00

(52) U.S. Cl. CPC G01F 23/00
USPC 73/290 R

(57) ABSTRACT

A fuel delivery unit in a fuel tank of a motor vehicle, having a surge pot, a fuel pump is arranged in the surge pot fuel out of the surge pot to an internal combustion engine of the motor vehicle, a pump holder for fastening the fuel pump in the surge pot, and a fill level sensor for determining the fill level in the fuel tank. The fill level sensor (13) is arranged on the pump holder.

### CROSS REFERENCE TO RELATED APPLICATIONS

This is a U.S. national stage of application No. PCT/EP2011/072503, filed on 13 Dec. 2011. Priority is claimed on German Application No. 10 2010 054 883.9 filed 17 Dec. 2010, the content of which is incorporated here by reference.

### BACKGROUND OF THE INVENTION

1. Field of the Invention

An object of the invention is a fuel delivery unit in a fuel tank of a motor vehicle, comprising a surge pot, a fuel pump arranged therein for delivering fuel from the surge pot to an internal combustion engine of the motor vehicle, a pump holder for fixing the fuel pump in the surge pot, and a fill level sensor for determining the fill level in the fuel tank.

2. Description of the Prior Art

Depending on the shape of the fuel tank, one or more fill level sensors are used. One fill level sensor is always located in the region of the surge pot. Additional fill level sensors are arranged in the fuel tank, the fill level sensor located in the region of the surge pot is normally fastened to the surge pot. Additional brackets, clips or similar fixing elements are arranged on the outside of the surge pot for receiving the fill level sensor. A diameter of the fuel delivery unit is determined by a diameter of an opening in the fuel tank through which the fuel delivery unit is installed. Consequently the diameter of the surge pot is reduced by the brackets arranged on the outside of the surge pot for the fill level sensor. This reduction in diameter causes a smaller volume of the surge pot. The volume of the surge pot also undergoes a further reduction since the surge pot is flattened on one side. This crosssection form of the surge pot deviating from the circular is necessary to allow the fill level sensor arranged on the outside, together with the surge pot, to be mounted through the opening in the fuel tank. As the volume of the surge pot is often predefined, conventional surge pots have a greater construction height in compensation. They are therefore unsuitable for use in motor vehicle fuel tanks with low construction height. In addition, mounting of the fuel delivery unit is not without problems. Because of the restricted space conditions in the fuel tank, the fuel delivery unit is pre-assembled before it is inserted in the fuel tank. Because of the fill level sensor arranged on the outside of the surge pot, to avoid damage, the fuel delivery unit must be inserted particularly carefully in the fuel tank. This is time-consuming and damage cannot be excluded completely.

### SUMMARY OF THE INVENTION

One embodiment of the invention is based on creating a fuel delivery unit, the surge pot of which has a minimum construction height and which can be inserted easily but nonetheless reliably in the fuel tank.

According to one embodiment of the invention, the fill level sensor is arranged on the pump holder.

By arranging the fill level sensor on the pump holder, the fill level sensor is now arranged in the surge pot and no longer on its outside. Consequently the surge pot can be designed with a larger crosssection, whereby a greater volume is achieved. Furthermore arranging the fill level sensor on the pump holder allows greater freedom in the design of the fixing elements for the fill level sensor. Because the pump holder already has a complex shape, the fixing elements to be provided on the pump holder do not lead to any significant increase in complexity and hence costs. In addition, the arrangement of the fill level sensor inside the surge pot has the advantage that damage to the fill level sensor on insertion of the fuel delivery unit in the fuel tank is avoided because of its protected position.

In an advantageous embodiment, the pump holder has fixing elements, preferably receivers and/or clips, with which the fill level sensor is arranged on and fastened to the pump holder.

To allow dismantling of the fill level sensor for maintenance or repair work, according to one embodiment, the fixing elements are formed for detachable connection of the fill level sensor with the pump holder.

A secure arrangement of the fixing elements on the pump holder is achieved in that they are connected integrally with the pump holder. Insofar as the pump holder is an injection molding of plastic, the fixing elements can easily be produced in the same work process during the injection molding of the pump holder.

To be able to measure the fill level in the fuel tank, the lever arm carrying the float must be guided out of the region of the pump holder over the upper edge of the surge pot into the fuel tank. To keep the length of the lever arm low, and hence the weight and costs low, the fill level sensor according to one embodiment of the invention is arranged in the upper region of the pump holder in relation to the installation position.

A further reduction in the length of lever arm is achieved in that the fixing elements are arranged on a strut of the pump holder, wherein the strut extends from the pump holder in the direction of the flange and hence upwards. This embodiment is particularly advantageous if the pump holder is arranged in the middle of the surge pot, remote from the upper region of the surge pot.

### BRIEF DESCRIPTION OF THE DRAWINGS

The invention is explained in more detail with reference to several embodiment examples. The drawings show:

FIG. 1 is a diagrammatic depiction of a fuel delivery unit according to the prior art,

FIG. 2 is the surge pot of the fuel delivery unit,

FIG. 3 is a further embodiment of a pump holder in a schematic depiction.

### DETAILED DESCRIPTION OF THE PREFERRED EMBODIMENTS

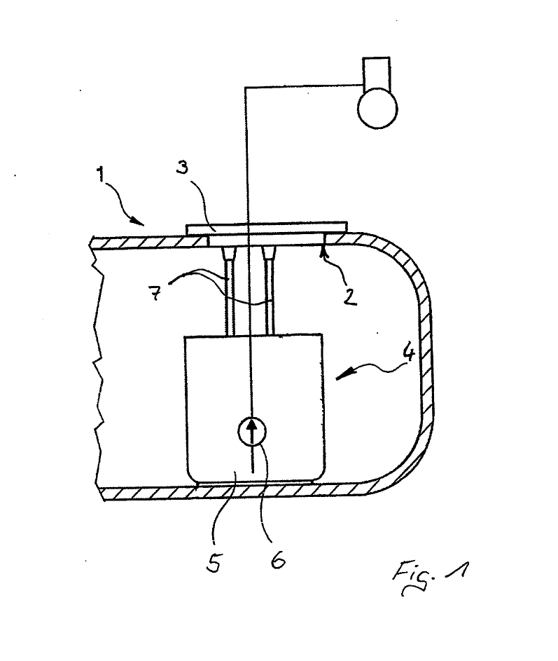

FIG. 1 shows a fuel tank 1 with an opening 2 which is closed by a flange 3. The fuel delivery unit 4 is introduced into the fuel tank 1 through the opening 2 and then mounted in the interior of the fuel tank 1. The fuel delivery unit 4 consists of a surge pot 5 with a fuel pump 6 arranged therein connected with the flange 3 by the support elements 7 and pre-tensioned against the floor of the fuel tank 1.

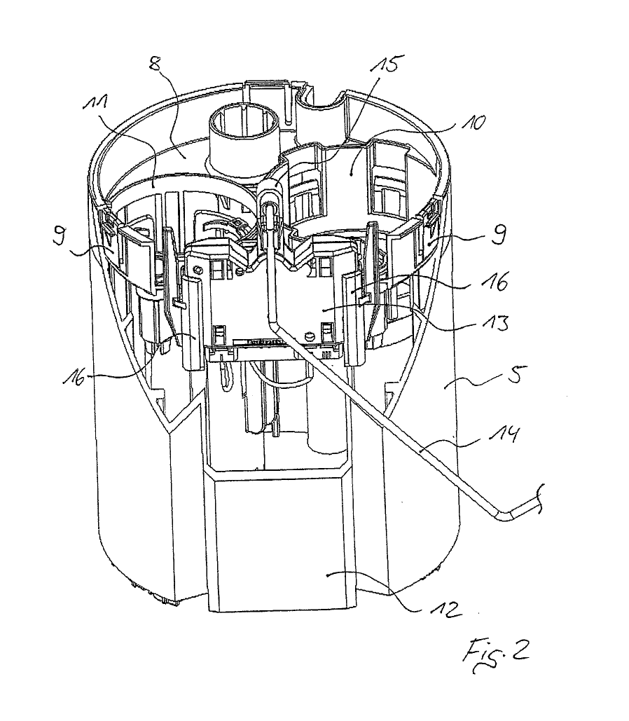

Arranged in the surge pot 5 in FIG. 2 is a pump holder 8 arranged in an upper region of the surge pot 5 in relation to the installation position. To fix the pump holder 8 to the surge pot 5, the pump holder 8 has two locking hooks 9 that engage on corresponding locking shoulders in the surge pot 5. The pump holder 8 has two circular recesses 10, 11 in which the fuel pump (not shown here) and a filter are inserted. The crosssection of the surge pot 5 is substantially circular. Only on one side does the surge pot 5 have a flattened area 12 on which a fill level sensor 13 is arranged. The fill level sensor 13 has a float (not shown) attached to a lever wire 14. The lever wire 14 is mounted rotatably in a clamp 15. The clamp 15 is in connection with a resistance network that generates electrical signals for the fill level depending on the pivot angle of the lever wire 14.

For the arrangement of the fill level sensor 13, the pump holder 8 has fixing elements formed as receivers 16 into which the fill level sensor 13 is inserted and locked. The receivers 16 are formed integrally with the pump holder 8 and are located in the upper region of the pump holder 8, so that the lever wire 14 protrudes over the edge of the surge pot 5 into the fuel tank 1.

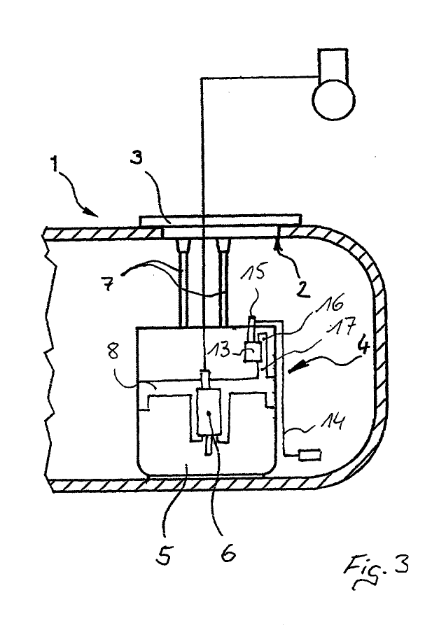

The pump holder 8 in FIG. 3 is slightly modified in relation to the pump holder in FIG. 2. The pump holder 8 has a strut 17 oriented towards the flange 3 and which protrudes beyond the upper edge of the surge pot 5. The fill level sensor 13 is arranged on this strut 17.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-6. (canceled)

7. A fuel delivery unit in a fuel tank of a motor vehicle, comprising:
a surge pot;
a fuel pump arranged in the surge pot and configured to deliver fuel from the surge pot to an internal combustion engine of the motor vehicle;
a pump holder configured to fix the fuel pump in the surge pot; and
a fill level sensor arranged on the pump holder and configured to determine a fill level in the fuel tank.

8. The fuel delivery unit as claimed in claim 7, wherein the pump holder has fixing elements that fasten the fill level sensor to the pump holder.

9. The fuel delivery unit as claimed in claim 8, wherein the fixing elements are configured to detachably connect the fill level sensor with the pump holder.

10. The fuel delivery unit as claimed in claim 8, wherein the fixing elements are integrally connected to the pump holder.

11. The fuel delivery unit as claimed in claim 7, wherein the fill level sensor is arranged in an upper region of the pump holder in relation to its installation position.

12. The fuel delivery unit as claimed in claim 8,
wherein the fixing elements are arranged on a strut of the pump holder, and
wherein the strut extends from the pump holder towards a flange used to seal an opening in the fuel tank.

13. The fuel delivery unit as claimed in claim 8, wherein the fixing elements are at least one of receivers and clips.

14. The fuel delivery unit as claimed in claim 9, wherein the fixing elements are integrally connected to the pump holder.
